(19) United States
(12) Patent Application Publication
(10) Pub. No.: US 2024/0383452 A1
(43) Pub. Date: Nov. 21, 2024

(54) FOOT BRAKE DEVICE FOR VEHICLES

(71) Applicant: Knorr-Bremse Systeme Fuer Nutzfahrzeuge GmbH, Muenchen (DE)

(72) Inventors: Balazs Viktor BIRKAS, Budapest (HU); Huba Nemeth, Budapest (HU); Gábor Fojtyik, Etyek (HU)

(21) Appl. No.: 18/689,791

(22) PCT Filed: Sep. 5, 2022
(86) PCT No.: PCT/EP2022/074589

§ 371 Date: Mar. 6, 2024

(30) Foreign Application Priority Data
Sep. 29, 2021 (EP) 21199881.0

(51) Int. Cl. B60T 7/04; G05G 5/03

(52) U.S. Cl. CPC B60T 7/042; G05G 5/03; B60T 2220/04

(57) ABSTRACT

A foot-brake-device (FBD) for vehicles, utility/commercial vehicles, includes a foot-brake-pedal (FBP) for driver activation, and a first/second foot-brake-sensor (FBS) coupled with the FBP, the first/second FBS determining an FBP position upon driver activation, and the first/second FBS generating a first/second electric-control-signal (ECS) corresponding to the FBP position. The second FBS functions as a back-up-sensor for failure of the first FBS. The FBD includes member(s) to generate counter-force(s) against which the FBP works upon activation, the counter-force being substantially proportional to the activation degree of the FBP and indicates the activation degree of the FBP to the driver. The members include first/second spring-elements with different characteristics. The FBD includes first/second electronic-control-device, the first/second ECS generated by the first/second FBS being received by the first/second electronic-control-device which generates a third/fourth ECS which activates brake actuator(s) to brake the vehicle in an amount corresponding to the activation degree of the FBP.

### FIELD OF THE INVENTION

The present invention relates to a foot brake device for vehicles, particularly utility vehicles or commercial vehicles, to a brake system for vehicles having such a foot brake device, and to a vehicle having such a foot brake device and/or such a brake system.

### BACKGROUND INFORMATION

Utility vehicles or commercial vehicles may include two brake systems for safety and redundancy reasons. Therein, the first brake system may be the primarily used, main system, whereas the second brake system serves as a back-up system for use in case of failure of the first system. The first brake system may be a substantially electrically or electronically controlled system, whereas the second brake system is a substantially fluidic, in particular pneumatic, controlled system, both systems being connected to a foot brake pedal which is activated by the driver of the vehicle for braking the vehicle. As an example, an electronic brake system (EBS) can be mentioned.

In normal operation, activation of the foot brake pedal by the driver operates the electronic first brake system which, e.g. by a foot brake sensor, generates an electronic signal as a first control or switching signal. This signal (e.g. a certain electric voltage) indicates the degree of activation of the foot brake pedal by the driver and thus the amount of deceleration of the vehicle intended by the driver. This first signal is received by an electronic control device, which, in turn, generates a further electronic signal. This latter signal is then fed into brake valves and/or brake actuators, which eventually generate a pneumatic pressure, i.e. the actual brake pressure being applied to and actuating the brakes of the vehicle.

In case that this electronic first brake system is inoperative or does not operate correctly or fails for whatever reason, the second, pneumatic brake system steps in as a back-up system for safely braking the vehicle. Therein, activation of the foot brake pedal by the driver generates a pneumatic signal as a second control or switching signal. This signal is a control pressure signal which is fed into brake valves and/or brake actuators which eventually generate a pneumatic pressure according to the second control signal. The generated pneumatic pressure is the actual brake pressure being applied to and actuating the brakes of the vehicle as intended by the vehicle driver.

Typically, pneumatic means that are provided to operate the second, pneumatic brake system in particular to generate the second control signal also serve the additional function to provide a pneumatic resistance or counter force or counter pressure in the foot brake pedal which is depressed by the driver for braking the vehicle. Therein, typically, the pneumatic resistance or counter force or pedal force increases with the amount or degree of activation or depression of the foot brake pedal, i.e. the pedal stroke, by the driver. Thus, the pneumatic resistance or counter force indicates the amount or strength or degree of braking the vehicle as intended by the driver. Accordingly, the driver has a certain feeling or impression when activating, i.e. engaging or depressing and disengaging or releasing, the foot brake pedal.

The brake system or the electronic brake system (EBS), respectively, can combine the electronic first brake system and the pneumatic second brake system and/or let these brake systems cooperate such that the brake actuators can process both the first, electronic control signal and/or the second, pneumatic control signal.

Under environmental, economical or other aspects, it may be intended to provide a purely or substantially electrical or electronic brake system in vehicles, particularly utility vehicles or commercial vehicles. In this case, the above-mentioned second, pneumatic brake system would be omitted. This may be a beneficial solution for purely or partly electrical vehicles. Electrical vehicles may no longer have a compressor and/or related devices on board for generating and conducting pressurized air that is needed for controlling and/or operating a pneumatic brake system. However, it is noted that also electrical vehicles may still have devices for generating and conducting pressurized air on board. Also for more or less conventional vehicles a purely or substantially electrical or electronic or electromechanical brake system may be provided, i.e. no longer a pneumatic brake system. In this case, the brake elements may no longer be controlled and/or activated by pneumatic pressure, i.e. pressurized air. Instead, the brake actuators, e.g. servo motors, may be operated by electric signals, thereby e.g. moving brake pads towards or away from a brake disk. Besides, the omission of a pneumatically operated brake system may also be an option for a vehicle which is configured to drive partly or fully automated or autonomous.

Thus, if a pneumatic brake system and/or pneumatic devices for generating and handling pressurized air are no longer fully or partly provided in a vehicle, there is a need for alternative solutions to provide the above mentioned functions that were previously fulfilled by the pneumatic brake system and/or the related pneumatic devices in a vehicle. This includes the case that only the pneumatic control signal is no longer provided, whereas the brake system as such may still be operated pneumatically, including the brake actuators which exert the actual brake pressure.

### SUMMARY OF THE INVENTION

In view of the aspect that a vehicle may no longer have means to operate the second, pneumatic brake system in particular to generate the pneumatic second control signal, it is an object of the present invention to accomplish non-pneumatic means which provide a resistance or counter force or counter pressure in the foot brake pedal which is depressed by the driver for braking the vehicle, wherein the amount or degree of such counter force informs the driver about the strength or degree of braking the vehicle as intended by the driver. Thus, a foot brake pedal shall be provided which can substantially be operated by the driver as usual, i.e. as the driver is accustomed to, although a pneumatic control signal is no longer provided for the foot brake pedal.

According to the present invention, this object is achieved by a foot brake device for vehicles, particularly utility vehicles or commercial vehicles, as defined herein, by a brake system for vehicles as defined herein, and by a vehicle, particularly a utility vehicle or commercial vehicle, as defined herein.

Thus, the invention provides a foot brake device for vehicles, particularly utility vehicles or commercial vehicles, comprising: a foot brake pedal for activation by the driver of the vehicle, and a first foot brake sensor being coupled with the foot brake pedal, wherein the first foot brake sensor is configured to determine a respective position of the foot brake pedal upon activation of the foot brake pedal by the driver, and wherein the first foot brake sensor is configured to generate a first electric control signal corresponding to the position of the foot brake pedal, characterized by at least one member which is configured to generate a physical counter force against which the foot brake pedal must work upon its activation by the driver, wherein the amount of the counter force is substantially proportional to the degree or amount of activation of the foot brake pedal by the driver and indicates the degree or amount of activation of the foot brake pedal to the driver.

According to the invention, the member which generates a physical counter force for the activation of the foot brake pedal is configured to give a kind of response or reaction to the driver informing him/her about the respective position or movement of the foot brake pedal upon its depression or release by the driver, thereby indicating the respective braking strength or braking power to the driver. Therein, the counter force or pedal force is no longer generated by pneumatic pressure, i.e. there is no pneumatic signal or pneumatic resistance or counter force when operating the foot brake pedal, as a pneumatic control signal is no longer provided by a pneumatic braking system and/or related pneumatic devices in the vehicle. Nevertheless, the counter force generating member is configured such that the driver has the same or a similar feeling and impression and handling of the foot brake pedal as with conventional foot brake pedals, i.e. there is no change in the driver's experience and his/her manner of operation of the vehicle brake. Accordingly, the foot brake pedal shall show a behavior as it is known by the driver from conventional foot brake pedals and to which behavior the driver is used. Thus, the driver does not have to specifically exercise or get accustomed to operate the foot brake device of the invention.

The member which generates a counter force for the foot brake pedal may have a characteristic such that the amount of the generated counter force is substantially linearly or non-linearly or irregularly proportional to the degree or amount of activation of the foot brake pedal by the driver. The term “proportional” as used in the context of this invention does not have to be understood only in its literal meaning. Rather, it shall be understood in a more general, broader sense and shall indicate any conceivable kind of a regular or irregular dependency or correspondence or ratio.

Specifically, the amount of the generated counter force, i.e. the strength with which the driver has to depress the foot brake pedal, can be substantially progressively or degressively proportional to the degree or amount of activation of the foot brake pedal. Herein, progressive proportionality means that the strength or force with which the driver has to depress the foot brake pedal does not increase linearly with the amount of activation or depression of the foot brake pedal, but rather increases with a higher rate as compared to the rate of activation of the foot brake pedal. In turn, degressive proportionality means that the strength or force to depress the foot brake pedal increases with a lower rate as compared to the rate of activation of the foot brake pedal. Furthermore, the amount of the generated counter force can be substantially directly or indirectly proportional to the degree of activation or depression of the foot brake pedal by the driver. Herein, direct proportionality means that the strength or force with which the driver has to depress the foot brake pedal increases with the amount of activation or depression of the foot brake pedal. In turn, indirect proportionality means that the strength or force to depress the foot brake pedal decreases with the amount of activation or depression of the foot brake pedal. It is to be understood that any of these regular or irregular proportionalities may also be combined, i.e. there may e.g. be a direct or indirect, progressive or degressive proportionality. Furthermore, during activation of the foot brake pedal by the driver, there may be different types and/or combinations of any of the above mentioned proportionalities over the time, i.e. over the process of activation of the foot brake pedal.

In an exemplary embodiment of the invention, the at least one member which generates a counter force for the foot brake pedal may include a spring element and/or a damping element and/or another force generating element. Suitable spring elements may include a mechanical spring, particularly a spiral spring, a coil spring or a leaf spring. Spring elements may also include a gas pressure spring. Suitable damping elements may include a hydraulic damper or a rubber damper. Any other suitable force generating element may also be conceivable, such as e.g. active elements or electromechanical force generating elements.

These counter force generating members may be configured and arranged and may cooperate with the foot brake pedal and with each other, if applicable, in different ways. Therein, for example, at least two of a spring element and/or a damping element may be connected in series and/or in parallel with each other. This encompasses an arrangement where e.g. two of these elements are connected in parallel with each other and where this arrangement is then connected in series with one or more further of these elements which again may or may not be connected in parallel with each other.

In a further embodiment the foot brake pedal and the at least one spring element and/or the at least one damping element may be configured and arranged such that the foot brake pedal upon its activation by the driver contacts one or more of the at least one spring element and/or the at least one damping element only after the foot brake pedal has been moved for a predetermined distance. In this case, the foot brake pedal may first travel freely for a certain distance without experiencing any counter force prior to reaching and contacting the counter force generating element. In case of two or more counter force generating elements, which may e.g. be arranged substantially in parallel, the foot brake pedal may first travel freely for a certain distance only with respect to one or more of the elements, whereas the one or more other elements may immediately be contacted by the foot brake pedal as of the start position. Other or supplementary configurations or arrangements of and/or manners of cooperation between the foot brake pedal and the counter force generating members may also be conceivable.

In a foot brake device according to an exemplary embodiment of the invention, two members for generating a counter force for the foot brake pedal are provided comprising a first spring element and a second spring element, these two spring elements having different characteristics and/or different physical properties and/or different geometries.

In this embodiment, the foot brake device includes a housing, a piston being coupled with the foot brake pedal and being reciprocally movable within the housing in conjunction with the movement of the foot brake pedal, and at least a first spring element to generate a counter force for the foot brake pedal, the first spring element being arranged within the housing, the first spring element with its one end substantially bearing against the housing and with its other end substantially bearing against the piston.

Is to be noted that the element “piston” does not necessarily have to be understood literally and/or technically as a piston, particularly a fluidically sealing piston. Rather, any kind of displaceable or sliding actuation or actuator element can also be included by the term “piston”.

This encompasses the embodiments that the first spring element either immediately and/or always contacts and bears against the piston, or that the first spring element is configured such that it bears against the piston with its respective other end only after the piston has been moved for a predetermined distance upon activation of the foot brake pedal by the driver. In this latter embodiment, there typically is a certain gap between the respective end of the first spring element and the piston in the relaxed, non-biased start position of the piston and the spring element. In this case, the piston, when being pushed by the foot brake pedal, first travels freely for the distance of the gap and only then enters into contact with the respective end of the first spring element and only then bears against and starts to compress the spring element. During the gap distance of free travel, the piston does not experience any counter force from the first spring element.

Furthermore, the foot brake device may include a second spring element to generate a counter force for the foot brake pedal, the second spring element being arranged within the housing, the second spring element with its one end substantially bearing against the housing and with its other end substantially bearing against the piston. As explained above for the first spring element, this may again encompass the embodiments that the second spring element either immediately and/or always contacts and bears against the piston, or that there is a certain gap between the respective end of the second spring element and the piston in the non-biased start position of the piston and the spring element. Accordingly, the second spring element is configured such that it bears against the piston with its respective end only after the piston has been moved over the gap distance upon activation of the foot brake pedal by the driver.

Furthermore, the first and second spring elements may be configured and arranged such that the first spring element has a larger cross section or diameter and the second spring element has a smaller cross section or diameter, wherein the second spring element is arranged substantially within the first spring element, i.e. the first spring element partly or fully encloses the second spring element. Besides, the first and second spring elements may have the same or different lengths. In the latter case, for example, the second spring element may have a longer axial length than the first spring element, so that the second spring element may at its one end or its both ends protrude axially from the first spring element. Besides, the first and second spring elements, in their arrangement within the housing, may axially be displaced against each other so that one spring element may protrude axially from the respective one end of the respective other spring element and vice-versa.

In the embodiments of the invention, the first spring element is a first coil spring, and the second spring element is either a second coil spring or a gas pressure spring.

In view of the above mentioned aspect that a pneumatic brake system and/or pneumatic devices for generating and handling pressurized air, specifically including the provision of a pneumatic, second control signal, may no longer be provided in a vehicle, there is a need for an alternative solution to provide those functions that were previously fulfilled by the secondary pneumatic brake system and/or the related pneumatic devices in a vehicle as regards the provision of a back-up system for safely braking the vehicle in case that the primary, substantially electric or electronic brake system is not operative or fails. Thus, there is a need to provide a secondary brake system which particularly is controlled non-pneumatically or non-fluidically.

To accomplish this secondary brake system, the foot brake device according to a further embodiment of the invention includes a second foot brake sensor being coupled with the foot brake pedal, wherein the second foot brake sensor is configured to determine a respective position of the foot brake pedal upon activation of the foot brake pedal by the driver, and wherein the second foot brake sensor is configured to generate a second electric control signal corresponding to the position of the foot brake pedal. Therein, the second foot brake sensor may be independent of the above mentioned first foot brake sensor and is in particular configured to operate as a back-up sensor in case of failure of the first foot brake sensor.

The first electric control signal generated by the first foot brake sensor and/or the second electric control signal generated by the second foot brake sensor are intended to eventually activate at least one brake actuator at or in the vicinity of the wheels of the vehicle to brake the vehicle in an amount corresponding to the degree of activation of the foot brake pedal by the driver. Therein, in a first version, the generated first electric control signal and/or the generated second electric control signal as such can be applied and inputted more or less directly into the one or more brake actuators to activate the vehicle brakes for braking the vehicle in an amount corresponding to the degree of activation of the foot brake pedal by the driver.

In a second, alternative version, electronic control devices or control units are provided and generally interconnected between the first and/or second foot brake sensors at the foot brake pedal and the brake actuators at the wheels of the vehicle. In this case, the foot brake device of the invention includes at least a first electronic control device, wherein the first electric control signal generated by the first foot brake sensor is received by the first electronic control device, and wherein the first electronic control device is configured to generate a third electric control signal which activates at least one brake actuator to brake the vehicle in an amount or strength corresponding to the degree or amount of activation of the foot brake pedal by the driver.

In case that the above mentioned second foot brake sensor is provided in the context of a secondary back-up brake system, the foot brake device of the invention further includes a second electronic control device, wherein the second electric control signal generated by the second foot brake sensor is received by the second electronic control device, and wherein the second electronic control device is configured to generate a fourth electric control signal which activates at least one brake actuator to brake the vehicle in an amount or strength corresponding to the degree or amount of activation of the foot brake pedal by the driver.

The above mentioned first and/or second foot brake sensors may operate under various physical or technical principles. Therefore, the first and/or second foot brake sensors can include magnetic and/or inductive and/or capacitive and/or optical sensor means to generate the first and/or second electric control signal. Other physical sensor means and methods may likewise be conceivable. In the sense of functional safety or security, the first and second foot brake sensors as such each may use different sensor means or methods in order to accomplish the aim that the second foot brake sensor is a back-up sensor for the first foot brake sensor, thus e.g. coping with issues of potential systematic errors or failures of one of the two utilized sensing means or methods.

In an exemplary embodiment of the invention, the first foot brake sensor and/or the second foot brake sensor includes a Hall sensor which cooperates with a magnetic device to generate the first and/or second electric control signal. Herein, the Hall sensor produces a voltage difference across an electrical conductor that is transverse to an electric current in the conductor and to an applied magnetic field perpendicular to the current. The voltage difference is indicative for the first and/or second electric control signal.

Furthermore, the invention also encompasses a brake system for vehicles, particularly utility vehicles or commercial vehicles, comprising a foot brake device as described above.

This brake system may additionally include an input interface for activation by the driver of the vehicle, the input interface being configured to enable additional driving and/or braking modes and/or braking means (arrangement and/or structure) for the vehicle, particularly enabling a one pedal driving (OPD) mode and/or comprising a deceleration actuator, the one pedal driving mode and/or the deceleration actuator particularly enabling a permanent braking mode and/or a motor braking mode and/or a retardation mode for the vehicle.

Further options in this respect may be the provision of braking by an electric engine functioning as a generator; the provision of a retarder as a further braking device, wherein the input interface can include a retarder lever; and braking by normal friction brakes which however are activated and/or controlled by the above mentioned input interface. In case of one pedal driving, the input interface generally can include a driving pedal.

Furthermore, the invention also provides a vehicle comprising a foot brake device as described above and/or a brake system as described above. The vehicle of the invention can particularly be configured as a utility vehicle, a commercial vehicle, a truck, a trailer, a bus, a passenger car, and/or a combination of a towing vehicle and a trailer. Additionally or alternatively, the vehicle can be configured as an electric, hybrid, fuel cell, hydrogen or conventional vehicle.

Further details and advantages of the invention will be explained in the following detailed description of various embodiments of the invention in combination with the attached drawings.

### BRIEF DESCRIPTION OF THE DRAWINGS

FIG. 1 shows a cross-sectional view of a part of the foot brake device of the invention in a first embodiment.

FIG. 2 shows a cross-sectional view of a part of the foot brake device of the invention in a second embodiment.

FIG. 3 shows a circuitry diagram of the foot brake device of the invention.

### DETAILED DESCRIPTION

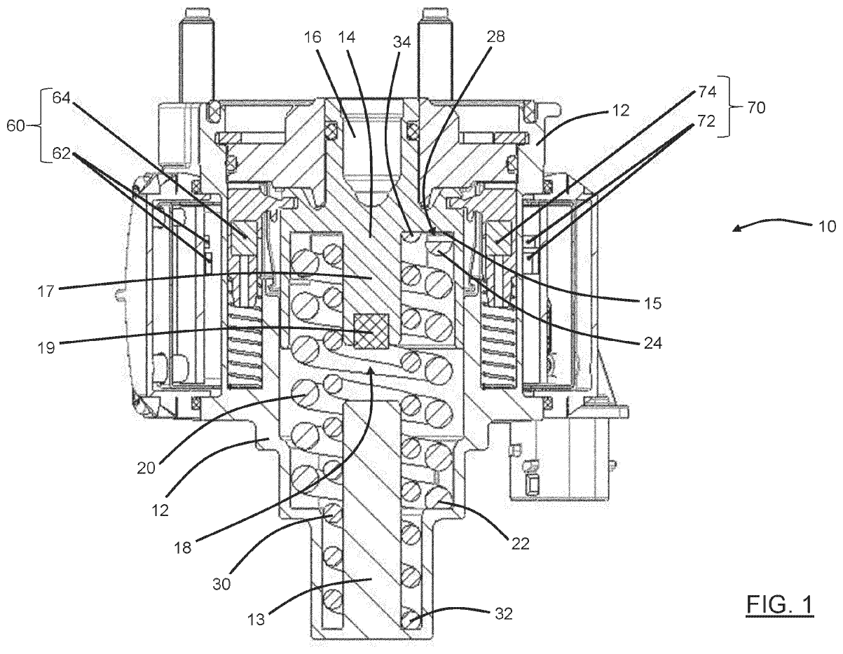

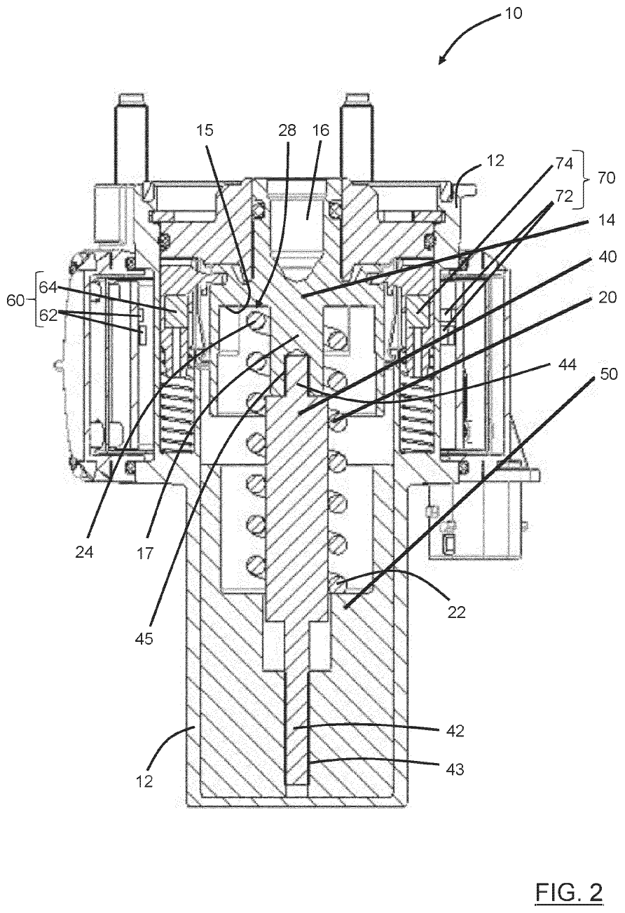

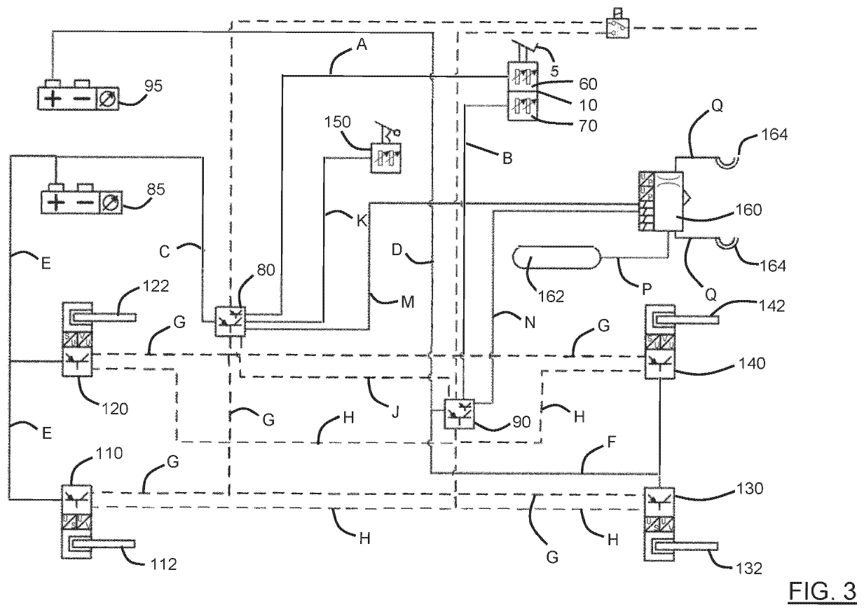

FIGS. 1 and 2 both show a cross-sectional view of a part of a foot brake device, namely a foot brake module 10. Although being slightly different as to their dimensions and certain details that will be explained below, the foot brake modules 10 of FIGS. 1 and 2 both include certain substantially identical parts, namely particularly a housing 12 and a piston 14. The piston 14 is substantially enclosed by the housing 12 and is reciprocally movable upwards and downwards (with respect to the orientation of FIGS. 1 and 2) within the housing 12. The piston 14 is coupled with a foot brake pedal of the foot brake device (the pedal not being shown in FIGS. 1 and 2 but as foot brake pedal 5 in FIG. 3). The foot brake pedal may directly or indirectly (e.g. through additional coupling means that are not shown in the drawings) for example be attached at the upper end of the piston 14, for example via a suitable attachment device 16. Thus, the piston 14 can move up and down substantially in conjunction with the movement of the foot brake pedal, i.e. the piston 14 moves downwards upon a depression of the foot brake pedal and moves upwards upon a release of the foot brake pedal.

Within the housing 12 of each of the foot brake modules 10 of FIGS. 1 and 2 there is arranged a first spring element 20, here specifically a first coil spring. This first spring element 20 functions to generate a counter force for the foot brake pedal, i.e. a pedal force that can be felt by the driver of the vehicle when activating, i.e. depressing and releasing, the foot brake pedal. Accordingly, the driver must work against this counter force of the spring element 20 upon activation of the foot brake pedal by the driver. Therein, the amount of the counter force is typically substantially proportional to the degree or amount of activation of the foot brake pedal by the driver. That is, the counter force substantially corresponds to the force that must be exerted by the driver to obtain a certain position of the foot brake pedal. Accordingly, the counter force substantially indicates the degree or amount of activation, and thus of the respective position, of the foot brake pedal to the driver.

Consequently, the counter force depends on the physical and technical characteristics of the respectively used spring element. As mentioned above, the spring element, i.e. the counter force generating member, can have a characteristic such that the amount of the generated counter force is linearly or non-linearly or irregularly proportional to the degree or amount of activation of the foot brake pedal by the driver. This includes that the proportionality may be a direct or indirect and/or a progressive or degressive proportionality.

As can be seen in FIGS. 1 and 2, the first spring element 20 substantially contacts or bears against the housing 12 with its lower end 22. Thereby, the housing 12 supports and holds the spring element 20. Furthermore, the first spring element 20 substantially contacts or bears against the piston 14 with its other, upper end 24. Particularly, the upper end 24 of the first spring element 20 bears against a downwards facing surface 15 of the piston 14. Thus, when the piston 14 is depressed, i.e. moved downwards, the downwards facing surface 15 of the piston 14 at first engages the upper end 24 of the spring 20.

FIGS. 1 and 2 show the piston 14 and the spring element 20 in a relaxed, non-biased, non-depressed position, i.e. in a basic or start position where the foot brake pedal is not depressed. In the embodiment shown in FIGS. 1 and 2, in this basic position, a free space or gap 28 exists between the upper end 24 of the spring element 20 and the downwards facing surface 15 of the piston 14. Thus, the spring element 20 (particularly the upper end 24 thereof) and the piston 14 are arranged and configured such that they get in contact and bear against each other only after the piston 14 has been moved for a predetermined distance upon activation of the foot brake pedal, namely for the distance of the gap 28. Accordingly, over this distance of free or idle travel, the piston 14 does not experience any counter force from the spring element 20.

It is to be noted that this latter specific embodiment as shown in FIGS. 1 and 2 is not mandatory. Thus, in another embodiment it can be provided that the gap 28 is not existent and that there is an immediate, direct contact between the upper end 24 of the spring element 20 and the downwards facing surface 15 of the piston 14 already in the non-biased start position.

In the embodiments shown in FIGS. 1 and 2, besides the first spring element 20, a second spring element 30, 40 is provided within the housing 12 to additionally generate a counter force for the foot brake pedal. Here, the embodiments of FIGS. 1 and 2 distinguish in that the second spring element in FIG. 1 specifically is a second coil spring 30, whereas the second spring element in FIG. 2 specifically is a gas spring or gas pressure spring 40.

Referring to FIG. 1, which shows a double spring arrangement, substantially identical or similar to the configuration of the first spring element 20, the second spring element 30 substantially contacts and bears against the housing 12 with its lower end 32 and substantially contacts and bears against the piston 14, particularly the downwards facing surface 15 of the piston 14, with its other, upper end 34. Furthermore, the first and second spring elements 20, 30 are configured such that the first spring element 20 has a larger cross section or diameter than the second spring element 30 which respectively has a smaller cross section or diameter than the first spring element 20. Therein, the first and second spring elements 20, 30 are arranged and further configured such the second spring element 30 is substantially located concentrically within the first spring element 20, i.e. the first spring element 20 substantially encloses the second spring element 30 concentrically.

In the embodiment shown in FIG. 1, the upper end 34 of the second spring element 30 directly contacts the downwards facing surface 15 of the piston 14 already in the shown non-biased start position. However, in another embodiment, as in the case of the first spring element 20 and the associated gap 28 as discussed above, there may a gap between the upper end 34 of the second spring element 30 and the downwards facing surface 15 of the piston 14 in the non-biased start position of the piston 14.

The second spring element 30 may be supported at or towards its lower end 32 by an axial protrusion 13 of the housing 12, the protrusion 13 forming a kind of a center axis for the circular spring element 30. At or towards its upper end 34, the second spring element 30 may be supported by an axial protrusion 17 of the piston 14, the protrusion 17 again forming a kind of a center axis for the circular spring element 30.

As shown in FIG. 1, the protrusion 17 of the piston 14 has a damper element 19 at its axially lower end, e.g. an elastic rubber damper element. Alternatively or additionally, such a damper element may likewise be provided at the axially upper end of the protrusion 13 of the housing 12. This damper element 19 functions to dampen or soften the impact of the protrusion 17 of the piston 14 onto the protrusion 13 of the housing 12 when the foot brake pedal is depressed to its maximum position, the piston 14 thereby being moved downwards to its lowest possible position where a further downwards movement of the piston 14 is stopped by the contact of the protrusion 17 of the piston 14 with the protrusion 13 of the housing 12. In turn, there is a clearance 18 between the axially lower end of the protrusion 17 of the piston 14 and the axially upper end of the protrusion 13 of the housing 12 when the protrusion 17 and the protrusion 13 do not contact each other. Consequently, this clearance 18 has its maximum extension when the foot brake pedal is not at all depressed and is in its non-biased start position.

In the embodiment shown in FIG. 1, the first spring element 20 and the second spring element 30 substantially are connected in parallel with each other, particularly when they are in contact with the piston 14. Other arrangements of the spring elements are likewise conceivable, including their connection in series with each other.

Referring to FIG. 2 where the second spring element specifically is a gas spring or gas pressure spring 40, the second spring element 40 with its lower end 42 again substantially contacts and bears against the housing 12 of the foot brake module 10 and with its other, upper end 44 substantially contacts and bears against the piston 14. Furthermore, the first and second spring elements 20, 40 are configured and arranged such that the first spring element 20 has a larger cross section or diameter than the second spring element 40, wherein the second spring element 40 is substantially located concentrically within the first spring element 20, i.e. the first spring element 20 substantially encloses the second spring element 40 concentrically.

More specifically, in the embodiment shown in FIG. 2, there is provided a spacer element 50 between the housing 12 and the lower end 42 of the gas pressure spring 40. Thus, the gas pressure spring 40 with its lower end 42 actually contacts and bears against the spacer element 50 which in turn contacts and bears against the housing 12. The gas pressure spring 40 encompasses threads 43 and 45 at its both ends 42 and 44. These threads 43, 45 respectively cooperate with corresponding threads in the spacer element 50 and the piston 14 to hold the gas pressure spring 40. With this arrangement, the gas pressure spring 40 may be preassembled as a unit with the piston 14 and the spacer element 50.

As further shown in FIGS. 1 and 2, the foot brake module 10 includes a first foot brake sensor 60 and a second foot brake sensor 70. The second foot brake sensor 70 typically is independent of and/or physically isolated from the first foot brake sensor 60 and is configured to operate as a back-up sensor in case of failure of the first foot brake sensor 60. Both the foot brake sensors 60, 70 are configured to determine a respective position of the foot brake pedal upon activation thereof by the driver of the vehicle. Therein, the first foot brake sensor 60 generates a first electric control signal and the second foot brake sensor 70 generates a second electric control signal. Both the first and second electric control signals correspond to the position of the foot brake pedal. By these electric control signals, at least one brake actuator is directly or indirectly activated to eventually brake the vehicle in an amount or with a strength corresponding to the degree of activation of the foot brake pedal by the driver.

In the embodiments shown in FIGS. 1 and 2, the first and second foot brake sensors 60, 70 each include magnetic sensor means, namely specifically a Hall sensor 62, 72 and a magnetic device 64, 74 which cooperate with each other to generate the first and second electric control signals according to the physical principles of the known Hall effect. Other sensor means and/or sensing principles are likewise conceivable.

FIG. 3 shows a circuitry diagram of the overall foot brake device. In this diagram, the solid lines typically designate analogous electric lines, namely both electric power supply lines as well as electric signal or control lines. The solid lines also designate some pneumatic lines. The dashed lines typically designate digital electric signal or control lines.

In FIG. 3, the foot brake module 10 is coupled with a foot brake pedal 5 which is activated by the driver of the concerned vehicle. The foot brake module 10 includes the first and second foot brake sensors 60, 70. The first foot brake sensor 60 is connected with the first electronic control device 80 through line A, i.e. the first electric control signal generated by the first foot brake sensor 60 is inputted into the first electronic control device 80. The second foot brake sensor 70 is connected with the second electronic control device or control unit 90 through line B, i.e. the second electric control signal generated by the second foot brake sensor 70 is inputted into the second electronic control device 90.

The first electronic control device 80 is supplied with electrical power from a first power source 85, e.g. a battery, through line C. The second electronic control device 90 is supplied with electrical power from a second power source 95, e.g. a battery, through line D. Furthermore, the first power source 85 supplies electrical power to brake actuators 110, 120 through line E, and the second power source 95 supplies electrical power to brake actuators 130, 140 through line F.

The first electronic control device 80 generates a third electric control signal which is inputted into all four brake actuators 110, 120, 130, 140 through digital signal lines G to control and activate the brake actuators 110, 120, 130, 140 to eventually brake the vehicle in an amount or at a rate corresponding to the degree of activation of the foot brake pedal 5 by the driver.

In an analogous manner, the second electronic control device 90 generates a fourth electric control signal which is inputted into all four brake actuators 110, 120, 130, 140 through digital signal lines H to control and activate the brake actuators 110, 120, 130, 140 to eventually brake the vehicle in an amount or at a rate corresponding to the degree of activation of the foot brake pedal 5 by the driver.

For actually braking the vehicle, each of the brake actuators 110, 120, 130, 140 acts on a respective brake disk 112, 122, 132, 142 which each is associated with a wheel of the vehicle.

The first electronic control device 80 and the second electronic control device 90 may be interlinked with each other by a digital signal line J. This serves an inter-communication between the first electronic control device 80 and the second electronic control device 90 which can act fully equivalent or equally. Thus, it can e.g. be provided that a control can mutually be accomplished either by the first electronic control device 80 and/or the second electronic control device 90.

Furthermore, an additional input interface 150 may be provided for activation by the driver of the vehicle, the input interface 150 for example being connected with the first electronic control device 80 through line K. A corresponding connection can also be given between the input interface 150 and the second electronic control device 90. The input interface 150 may be configured to enable additional driving and/or braking modes and/or braking means for the vehicle, particularly enabling a one pedal driving mode and/or comprising a deceleration actuator. The one pedal driving mode and/or the deceleration actuator may particularly be configured to enable a permanent braking mode and/or a motor braking mode and/or a retardation mode for the vehicle.

Further options with respect to input interface 150 may be the provision of braking by an electric engine functioning as a generator; the provision of a retarder as a further braking device, wherein the input interface can include a retarder lever; and braking by normal friction brakes which are activated and/or controlled by the above mentioned input interface. In case of one pedal driving, the input interface generally also can include a driving pedal.

Furthermore, the first electronic control device 80 and the second electronic control device 90 may be connected with a trailer coupling device 160 through lines M and N.

While the primary vehicle (e.g. a truck), which includes the overall foot brake device as shown in FIG. 3, may be a purely electric vehicle and/or a vehicle which does not include a pneumatic braking system, a trailer of this vehicle may be a conventional trailer, i.e. a trailer which still is operated with a pneumatic braking system. In order to supply the trailer with pressurized air for the pneumatic braking system, the primary vehicle (truck) may encompass a pressurized air tank 162 which may e.g. be filled and operated by an electric compressor which produces pressurized air. Such pressurized air is then supplied from the tank 162 to the trailer through pneumatic lines P and Q and trailer coupling valves 164 at the trailer coupling device 160.

### The List of Reference Signs is as Follows

5 foot brake pedal
10 foot brake module
12 housing
13 axial protrusion of housing
14 piston
15 downwards facing surface of piston
16 attachment device
17 axial protrusion of piston 14
18 clearance
19 damper element
20 first spring element, first coil spring
22 lower end of first spring element
24 upper end of first spring element
28 gap
30 second spring element, second coil spring
32 lower end of second spring element
34 upper end of second spring element
40 second spring element, gas pressure spring
42 lower end of second spring element
43 threads
44 upper end of second spring element
45 threads
50 spacer element
60 first foot brake sensor
62 Hall sensor
64 magnetic device
70 second foot brake sensor
72 Hall sensor
74 magnetic device
80 first electronic control device
85 first power source, battery
90 second electronic control device
95 second power source, battery
110 brake actuator
112 brake disk
120 brake actuator
122 brake disk
130 brake actuator
132 brake disk
140 brake actuator
142 brake disk
150 input interface
160 trailer coupling device
162 pressurized air tank
164 trailer coupling valves
A. . . . N electric lines
P, Q pneumatic lines AMENDMENTS TO THE CLAIMS:

1-19. (canceled)

20. A foot brake device for a vehicle, including a utility vehicle and/or a commercial vehicle, comprising:
a foot brake pedal for activation by a driver of the vehicle;
a first foot brake sensor, which is coupled with the foot brake pedal, wherein the first foot brake sensor is configured to determine a respective position of the foot brake pedal upon activation of the foot brake pedal by the driver, and wherein the first foot brake sensor is configured to generate a first electric control signal corresponding to the position of the foot brake pedal; and
at least one member configured to generate a physical counter force against which the foot brake pedal must work upon its activation by the driver, wherein the amount of the counter force is substantially proportional to the degree of activation of the foot brake pedal by the driver and indicates the degree of activation of the foot brake pedal to the driver.

21. The foot brake device of claim 20, wherein the at least one member, which generates the counter force for the foot brake pedal, has a characteristic such that an amount of a generated counter force is substantially proportional, linearly or non-linearly or irregularly, to a degree of activation of the foot brake pedal by the driver.

22. The foot brake device of claim 20, wherein the at least one member, which generates the counter force for the foot brake pedal, includes at least one of the following: (i) a spring element, including a mechanical spring, a spiral spring, a coil spring, a leaf spring, or a gas pressure spring, and/or (ii) a damping element, including a hydraulic damper or a rubber damper.

23. The foot brake device of claim 22, wherein at least two of a spring element and/or a damping element are connected in series and/or in parallel with each other, and/or wherein the foot brake pedal and the at least one spring element and/or the at least one damping element are configured and arranged such that the foot brake pedal upon its activation by the driver contacts one or more of the at least one spring element and/or the at least one damping element only after having been moved for a predetermined distance.

24. The foot brake device of claim 22, further comprising:
two members for generating a counter force for the foot brake pedal, wherein the two members include a first spring element and a second spring element with different characteristics.

25. The foot brake device of claim 20, further comprising:
a second foot brake sensor, which is coupled with the foot brake pedal, wherein the second foot brake sensor is configured to determine a respective position of the foot brake pedal upon activation of the foot brake pedal by the driver, and wherein the second foot brake sensor is configured to generate a second electric control signal corresponding to the position of the foot brake pedal.

26. The foot brake device of claim 25, wherein the second foot brake sensor is independent of the first foot brake sensor, and is configured to operate as a back-up sensor for a failure of the first foot brake sensor.

27. The foot brake device of claim 25, wherein the first electric control signal generated by the first foot brake sensor and/or the second electric control signal generated by the second foot brake sensor activate at least one brake actuator to brake the vehicle in an amount corresponding to the degree of activation of the foot brake pedal by the driver.

28. The foot brake device of claim 20, further comprising:
a first electronic control device, wherein the first electric control signal generated by the first foot brake sensor is received by the first electronic control device, and wherein the first electronic control device is configured to generate a third electric control signal which activates at least one brake actuator to brake the vehicle in an amount corresponding to the degree of activation of the foot brake pedal by the driver.

29. The foot brake device of claim 25, further comprising:
a second electronic control device, wherein the second electric control signal generated by the second foot brake sensor is received by the second electronic control device, and wherein the second electronic control device is configured to generate a fourth electric control signal which activates at least one brake actuator to brake the vehicle in an amount corresponding to the degree of activation of the foot brake pedal by the driver.

30. The foot brake device of claim 25, wherein the first foot brake sensor and/or the second foot brake sensor include a magnetic means and/or an inductive means and/or a capacitive means and/or optical sensor means to generate the first electric control signal and/or the second electric control signal.

31. The foot brake device of claim 25, wherein the first foot brake sensor and/or the second foot brake sensor includes a Hall sensor which cooperates with a magnetic device to generate the first electric control signal and/or the second electric control signal.

32. The foot brake device of claim 22, further comprising:
a housing;
a piston, which is coupled with the foot brake pedal and which is reciprocally movable within the housing in conjunction with the movement of the foot brake pedal; and
at least a first spring element to generate a counter force for the foot brake pedal, the first spring element being arranged within the housing, the first spring element with its one end substantially bearing against the housing and with its other end substantially bearing against the piston.

33. The foot brake device of claim 32, further comprising:
a second spring element to generate a counter force for the foot brake pedal, the second spring element being arranged within the housing, the second spring element with its one end substantially bearing against the housing and with its other end substantially bearing against the piston,
wherein the first and second spring elements are configured so that the first spring element has a larger diameter and the second spring element has a smaller diameter, and so that the second spring element is arranged substantially within the first spring element.

34. The foot brake device of claim 32, wherein the first spring element includes a first coil spring, and wherein the second spring element includes a second coil spring or a gas pressure spring.

35. The foot brake device of claim 32, wherein the first spring element and/or the second spring element are configured so that they bear against the piston with their respective other end only after the piston has been moved for a predetermined distance upon activation of the foot brake pedal by the driver.

36. A brake system for a vehicle, including a utility vehicle and/or a commercial vehicle, comprising:
a foot brake device, including:
a foot brake pedal for activation by a driver of the vehicle;
a first foot brake sensor, which is coupled with the foot brake pedal, wherein the first foot brake sensor is configured to determine a respective position of the foot brake pedal upon activation of the foot brake pedal by the driver, and wherein the first foot brake sensor is configured to generate a first electric control signal corresponding to the position of the foot brake pedal; and
at least one member configured to generate a physical counter force against which the foot brake pedal must work upon its activation by the driver, wherein the amount of the counter force is substantially proportional to the degree of activation of the foot brake pedal by the driver and indicates the degree of activation of the foot brake pedal to the driver.

37. The brake system of claim 36, further comprising:
an input interface for activation by the driver of the vehicle, the input interface being configured to enable additional driving and/or braking modes and/or braking means for the vehicle, including enabling a one pedal driving mode and/or including a deceleration actuator, the one pedal driving mode and/or the deceleration actuator enabling a permanent braking mode and/or a motor braking mode and/or a retardation mode for the vehicle.

38. A vehicle, including a utility vehicle and/or a commercial vehicle, comprising:
a foot brake device, including:
a foot brake pedal for activation by a driver of the vehicle;
a first foot brake sensor, which is coupled with the foot brake pedal, wherein the first foot brake sensor is configured to determine a respective position of the foot brake pedal upon activation of the foot brake pedal by the driver, and wherein the first foot brake sensor is configured to generate a first electric control signal corresponding to the position of the foot brake pedal; and
at least one member configured to generate a physical counter force against which the foot brake pedal must work upon its activation by the driver, wherein the amount of the counter force is substantially proportional to the degree of activation of the foot brake pedal by the driver and indicates the degree of activation of the foot brake pedal to the driver.

39. A vehicle, including a utility vehicle and/or a commercial vehicle, comprising:
a brake system, including a foot brake device, which includes:
a foot brake pedal for activation by a driver of the vehicle;
a first foot brake sensor, which is coupled with the foot brake pedal, wherein the first foot brake sensor is configured to determine a respective position of the foot brake pedal upon activation of the foot brake pedal by the driver, and wherein the first foot brake sensor is configured to generate a first electric control signal corresponding to the position of the foot brake pedal; and
at least one member configured to generate a physical counter force against which the foot brake pedal must work upon its activation by the driver, wherein the amount of the counter force is substantially proportional to the degree of activation of the foot brake pedal by the driver and indicates the degree of activation of the foot brake pedal to the driver.
